(19) United States
(12) Patent Application Publication
(10) Pub. No.: US 2025/0158930 A1
(43) Pub. Date: May 15, 2025

(54) COMMUNICATION APPARATUS, COMMUNICATION SYSTEM, COMMUNICATION METHOD, AND PROGRAM

(71) Applicant: NIPPON TELEGRAPH AND TELEPHONE CORPORATION, Tokyo (JP)

(72) Inventors: Katsuma MIYAMOTO, Tokyo (JP); Shinya KAWANO, Tokyo (JP); Hiroki KANO, Tokyo (JP); Koji SUGISONO, Tokyo (JP)

(21) Appl. No.: 18/839,170

(22) PCT Filed: Feb. 25, 2022
(86) PCT No.: PCT/JP2022/007919

§ 371 Date: Aug. 16, 2024

(51) Int. Cl. H04L 47/2441

(52) U.S. Cl. CPC H04L 47/2441

(57) ABSTRACT

A communication device that performs packet communication includes: a data storage unit that holds a rule of a value added service policy; a control unit that adds the rule of a certain terminal to the data storage unit in response to a start of communication of the terminal; and a reception unit that receives a packet related to communication of the terminal, in which the control unit executes a process related to a value added service for the packet on the basis of the added rule.

### TECHNICAL FIELD

The present invention relates to a communication device that performs packet communication.

### BACKGROUND ART

A configuration in which a packet transmitted from a terminal is transferred to an external server by a gateway (GW) is widely used as a communication form. The GW includes, for example, a network address port translation (NAPT) function.

A GW that provides a value added service (VAS) such as packet filtering (referred to as a VAS-GW) may be provided between the GW and the external server. The VAS-GW generally executes processing related to the value added service on the basis of 5 tuples of a packet.

### CITATION LIST

### Non Patent Literature

Non Patent Literature 1: Suzuki et al., “Core Network (EPC) for LTE” NTT DOCOMO Technical Journal Vol. 19, No. 1, April 2011.
https://www.nttdocomo.co.jp/binary/pdf/corporate/technology/rd/technical journal/bn/vol19_1/vol19_1_026jp.pdf
Non Patent Literature 2: Juniper NETWORKS, “Network Address Port Translation”, 17 Feb. 2021.
https://www.juniper.net/documentation/us/en/software/junos/interfaces-adaptive-services/topics/topic-map/network-address-port-translation.html

### SUMMARY OF INVENTION

### Technical Problem

In the related art, the VAS-GW also needs to hold a rule related to a terminal that is not communicating. Therefore, in an environment where there are a large number of terminals, the number of entries of the rule to be searched becomes large regardless of whether or not the terminals are performing communication, and it takes time to apply the rule related to the value added service. As a result, performance degradation may occur.

The present invention has been made in view of the above points, and an object of the present invention is to provide a technology capable of excluding a rule regarding a terminal that is not performing communication in an apparatus that provides a value added service for packet communication.

### Solution to Problem

According to the disclosed technology, there is provided a communication device that performs packet communication, the communication device including:
a data storage unit that holds a rule of a value added service policy;
a control unit that adds a rule for a certain terminal to the data storage unit using a start of communication of the certain terminal as a trigger; and
a reception unit that receives a packet related to communication of the terminal,
in which the control unit executes processing related to a value added service for the packet on the basis of the added rule.

### Advantageous Effects of Invention

According to the disclosed technology, there is provided a technology that enables an apparatus that provides a value added service for packet communication to exclude a rule related to a terminal that is not performing communication.

### BRIEF DESCRIPTION OF DRAWINGS

FIG. 1 is a diagram illustrating a basic system configuration.

FIG. 2 is a diagram for describing the problem.

FIG. 3 is a diagram for describing an overview of the embodiment.

FIG. 4 is a diagram for describing an operation example.

FIG. 5 is a diagram for describing a configuration example of a device.

FIG. 6 is a diagram illustrating a hardware configuration example of the device.

### DESCRIPTION OF EMBODIMENTS

Hereinafter, an embodiment of the present invention (present embodiment) will be described with reference to the drawings. The embodiment described below is merely an example, and embodiments to which the present invention is applied are not limited to the following embodiment.

### (Basic Configuration)

First, a configuration and operation of a basic system related to the present embodiment will be described, and then problems will be described.

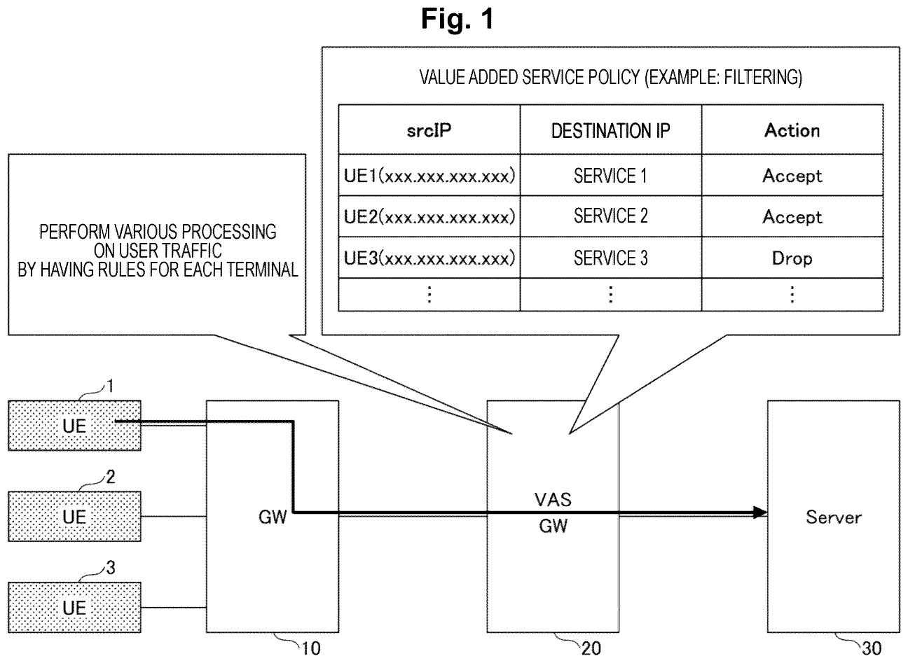

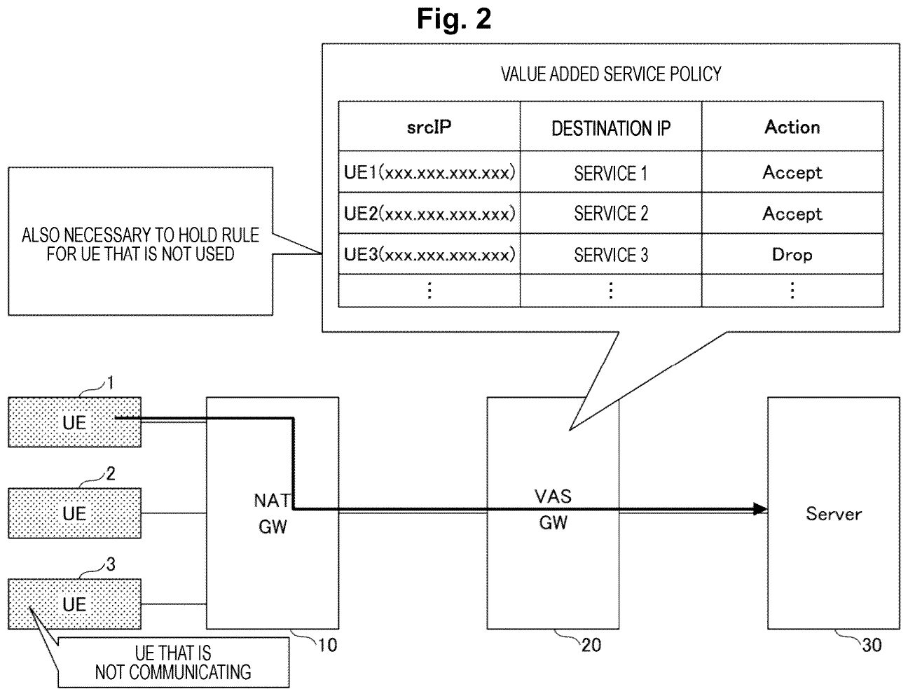

FIG. 1 illustrates a configuration example of a system. FIG. 1 (and FIG. 2) illustrates an example of a configuration not including a function according to the present invention in order to describe a problem. FIGS. 1 and 2 are not publicly known drawings.

As illustrated in FIG. 1, the present system includes a GW 10, a value added service-gateway (VAS-GW) 20, and a server 30, and three pieces of user equipment (UE) 1 to 3 are connected to the GW 10. Furthermore, the devices are connected by a wired or wireless network, and can communicate with each other as illustrated in the drawing.

The UE is an apparatus (device) that transmits and receives packet communication. The UE is, for example, a PC, a smartphone, an IoT device, or the like. The UE may be referred to as a terminal.

The GW 10 may be any device as long as it is a network device that processes a packet. The GW 10 has network functions such as L2/L3 transfer, a firewall, VPN connection, DPI, and proxy. The GW 10 may be referred to as a communication device.

The GW 10 may be an S-GW or a P-GW in the EPC, a UPF in 5GC, a base station (eNodeB, gNodeB, or the like), a router, a switch, or the like. Furthermore, the GW 10 may be a physical device or a virtual device.

The content described with respect to the GW 10 also applies to the VAS-GW 20. The VAS-GW 20 is different from the GW 10 in having a function of providing a value added service.

In FIG. 1, three pieces of UE 1 to 3 are connected to a GW 10 and communicate with a server 30 connected thereto. The server 30 is, for example, an application server. The VAS-GW 20 is installed between the GW 10 and the server 30. The VAS-GW 20 provides a value added service described below, for example, for user communication.
Packet filtering
QoS control (prioritizing communication from a specific UE/specific port, or the like).
Detecting an abnormality of communication (anomaly)
Policy-based routing

In these processes, the VAS-GW 20 looks at the packet header (5 tuple or the like) of the received packet and determines whether or not the process for the packet is necessary. Note that 5 tuples are a transmission source IP address, a transmission source port number, a destination IP address, a destination port number, and a protocol number.

As an example, the VAS-GW 20 holds a value added service policy for filtering as illustrated in FIG. 1. In the value added service policy, it is possible to perform various processes on user traffic by having a rule for each piece of UE.

In addition, for example, in a configuration in which a large number of pieces of UE are connected, the NAPT function is provided in the GW 10 as illustrated in FIG. 2. In FIG. 2, this is illustrated as NAT-GW 10. By performing network address port translation (NAPT) in the NAT-GW 10, it is possible to conceal the address of the UE and save the global IP address. Note that the processing of the NAPT may be referred to as address translation. “NAPT” also includes an operation of performing only address translation without performing port number translation.

### (Problems)

A problem will be described with reference to FIG. 2. The VAS-GW 20 holds a rule for each piece of UE and performs filtering and QoS control for each piece of UE. In such a case, entry of rules according to the number of pieces of UE is required, and as the number of pieces of UE increases, the number of entries also increases. For example, in a case of IoT terminals in which an enormous number is assumed, it is assumed that the number of entries corresponding to the IoT terminals is also enormous.

In the related art, there is also an entry for UE that is not communicating at all in a value added service policy. Therefore, it takes time for the VAS-GW 20 to search for a rule, and there is a possibility of performance degradation.

### Technology of Embodiment

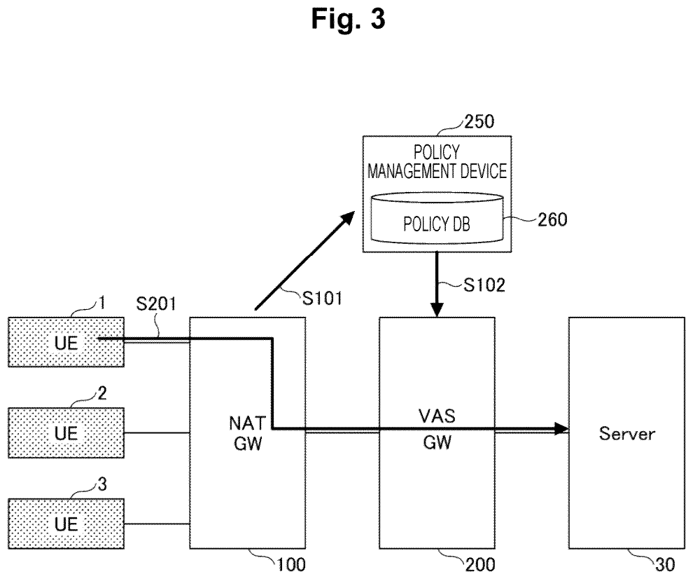

Hereinafter, a technique according to the present embodiment for solving the above problems will be described. FIG. 3 illustrates a system configuration and an outline of an operation according to the present embodiment. The system configuration illustrated in FIG. 3 basically corresponds to a configuration in which a policy management device 250 is added to the configuration illustrated in FIG. 1 or 2. Furthermore, the NAT-GW 100 and the VAS-GW 200 correspond to the GW described in FIGS. 1 and 2 to which the function according to the present invention is added.

The VAS-GW 200 acquires the entry (rule) of the value added service policy from the policy management device 250 in S102 at the timing of the communication start signal notified from the NAT-GW 100 in S101.

As a result, the VAS-GW 200 can hold the rule (entry) of the value added service policy of only the UE that is performing communication. Therefore, an entry related to a terminal that is not communicating can be excluded, and as a result, performance improvement can be realized.

Note that the VAS-GW 200 may delete an entry related to a certain UE held in the VAS-GW 200 when communication related to the UE does not occur at all in a predetermined period. Furthermore, regarding an entry related to a certain UE held in the VAS-GW 200, the VAS-GW 200 may delete the entry when detecting a signal indicating that the communication of the UE is terminated (for example, the bearer is disconnected).

Note that the VAS-GW 200 may be referred to as a value added service providing device. In addition, both the NAT-GW 100 and the VAS-GW 200 may be referred to as communication devices.

As for the NAT-GW 100 that performs notification of communication start, in addition to the S-GW, P-GW, UPF, base station, router, switch, and the like as described above, any device may be used as long as the device can recognize the session state of the UE, such as a radius server, a DHCP server, and a 4G/5G core function unit (SMF, AMF, and the like). The NAT-GW 100 may be a home gateway for home use, a CPE, or the like. Furthermore, the NAT-GW 100 may be replaced with a device having no NAPT function.

The policy management device 250 as a notification destination of communication start may be any device as long as the device has a function of selecting a device whose setting needs to be changed and a function of setting the device. The policy management device 250 may be a device such as an OpenFlow Controller that can operate the GW.

In addition, the function of the policy management device 250 may be provided in the VAS-GW 200. That is, the notification of the communication start in S101 illustrated in FIG. 3 may be made from the NAT-GW 100 to the VAS-GW 200. In this case, the VAS-GW 200 that has received the notification generates an entry of a rule for the UE that starts communication.

The trigger for performing the notification of the communication start from the NAT-GW 100 to the policy management device 250 is, for example, the start of the NAPT session in the NAT-GW 100, establishment of a bearer (communication path) between the NAT-GW 100 and a communication destination (for example, the UE or the server 30), address allocation using the DHCP function to the UE by the NAT-GW 100, or the like.

The information transmitted from the NAT-GW 100 as a signal for communication start in S101 may be any information as long as the information can identify that communication of a specific UE is started. This information may be referred to as communication start information.

NAPT session information or DHCP address allocation information (allocated address) may be added to information transmitted from the NAT-GW 100 as a signal for communication start. NAPT session information and DHCP address allocation information (allocated address) may be added to information transmitted from the NAT-GW 100 as a signal for communication start.

Here, session information of the NAPT will be described. In the NAT-GW 100, a translation rule such as an IP address and a port number is held as an NAPT rule. When communication matching the NAPT rule occurs, a session of the NAPT is generated, and the IP address and the port number of the communication matching the session are translated. The information about the session is NAPT session information. The session information may be referred to as translation information.

By including session information of the NAPT, address allocation information by DHCP, or the like in the information transmitted as a signal for communication start, it is possible to follow the dynamically changing IP address/port number.

### Specific Operation Example

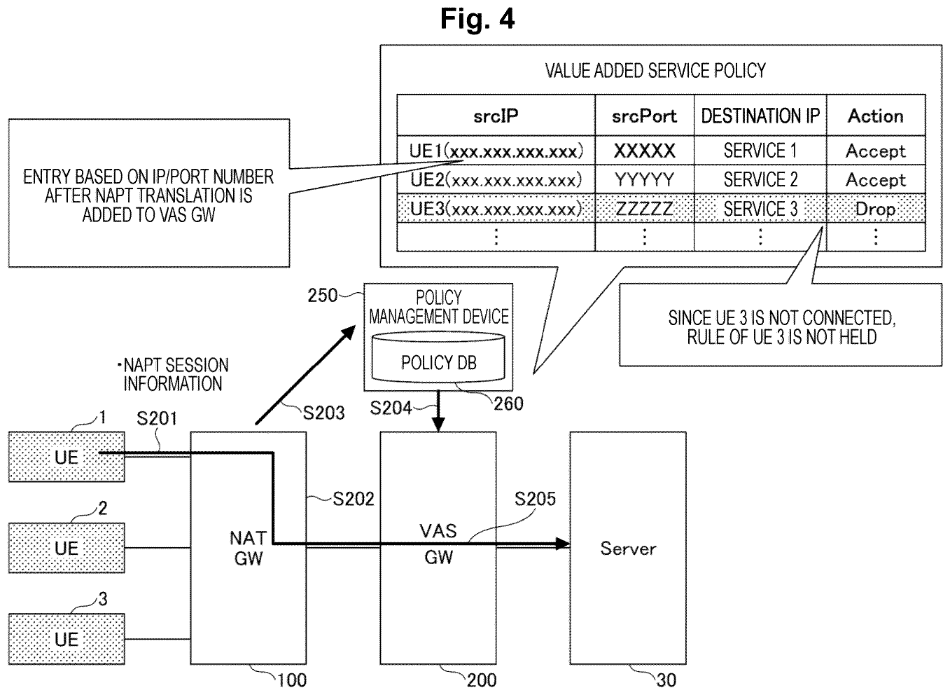

An operation example in a case where the NAPT session information is used as the information indicating the start of communication will be described with reference to FIG. 4.

In S201, the UE 1 starts communication. In S202, when detecting that the communication matches the NAPT rule, the NAT-GW 100 generates NAPT session information and transmits the NAPT session information to the policy management device 250 in S203.

After transmitting the NAPT session information, the NAT-GW 100 transmits the packet after NAPT translation related to the communication of the UE 1 to the VAS-GW 200.

The session information transmitted from the NAT-GW 100 to the policy management device 250 is, for example, “5 tuples before translation and 5 tuples after translation”. Further, the session information may be “a part of 5 tuples before translation and a part of 5 tuples after translation”. Specifically, the session information transmitted from the NAT-GW 100 to the policy management device 250 may be “transmission source IP address and transmission source port number before translation and transmission source IP address and transmission source port number after translation”.

Upon receiving the NAPT session information, the policy management device 250 generates a rule (entry) of a value added service policy for the UE 1 using the NAPT session information. For example, it is assumed that a rule having “transmission source IP address before translation, transmission source port number before translation” for the UE 1 is stored in a policy DB 260 of the policy management device 250.

Upon receiving “transmission source IP address and transmission source port number before translation and transmission source IP address and transmission source port number after translation” as the NAPT session information from the NAT-GW 100, the policy management device 250 generates a rule in which “transmission source IP address before translation, transmission source port number before translation” in the above rule is changed to “transmission source IP address, transmission source port number after translation”.

In S204, the policy management device 250 notifies the VAS-GW 200 of the generated rule. The VAS-GW 200 adds the rule as an entry in the value added service policy (table). FIG. 4 illustrates that an entry based on the IP address and port number after NAPT translation is added for UE1. In addition, it is indicated that since the UE 3 is not connected, the rule of the UE 3 is not held.

In S205, the VAS-GW 200 executes processing on the communication from the UE 1 based on 5 tuples after NAPT translation.

Note that, even before the entry of the rule for the UE 1 is added to the VAS-GW 200 after the communication of the UE 1 is started, the packet related to the communication of the UE 1 is transmitted from the NAT-GW 100 to the VAS-GW 200. The VAS-GW 200 holds the packet received before the entry is added in the buffer, and processes the packet held in the buffer after the entry is added.

Regarding the buffer holding of the received packet before the entry is added, the VAS-GW 200 desirably holds the packet in the buffer at the time of the TCP 3-way handshake. This is because, after the 3-way handshake of the TCP, data transmission is started by the established connection, and thus there is a possibility that buffer overflow due to a large number of packets from the UE 1 occurs. By holding the packet in the buffer at the time of the TCP 3-way handshake, buffer overflow can be prevented.

### Device Configuration Example

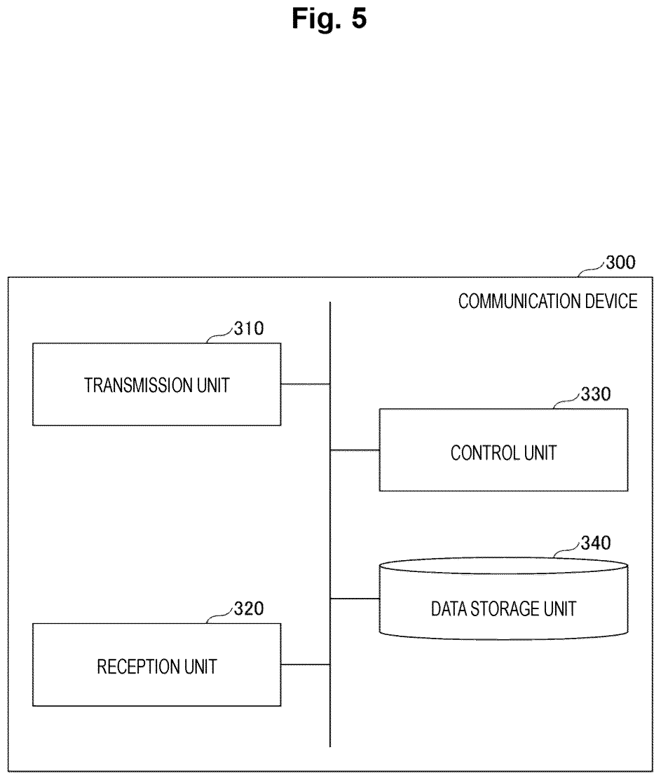

FIG. 5 is a configuration diagram illustrating a functional configuration of a communication device 300 corresponding to the NAT-GW 100 or the VAS-GW 200. FIG. 5 also corresponds to a functional configuration of the policy management device 250.

As illustrated in FIG. 5, the communication device 300 includes a transmission unit 310 that performs packet transmission, a reception unit 320 that performs packet reception, a control unit 330 that performs processing and the like on a packet, and a data storage unit 340 that stores various data.

When the communication device 300 operates as the VAS-GW 200, the data storage unit 340 holds the rule of the value added service policy. The control unit 330 adds a rule for a certain terminal to the data storage unit 340 with the start of communication of the terminal as a trigger. The reception unit 320 receives a packet related to communication of the terminal, and the control unit 330 executes processing related to a value added service on the received packet on the basis of the added rule.

When the communication device 300 operates as the NAT-GW 100, the control unit 330 detects the start of communication of a certain terminal, and the transmission unit 310 transmits communication start information indicating that the terminal has started communication, and transmits a packet related to communication of the terminal to the VAS-GW 200 having a rule of a value added service policy generated on the basis of the communication start information after the transmission of the communication start information.

When the communication device 300 operates as the policy management device 250, the reception unit 320 receives the communication start information, and the control unit 330 generates the rule of the value added service policy on the basis of the communication start information. The transmission unit 310 transmits the rule to the VAS-GW 200.

### Hardware Configuration Example

The communication device 300 corresponding to the NAT-GW 100, the VAS-GW 200, or the policy management device 250 can be implemented using, for example, a dedicated hardware circuit, or can be implemented by causing a computer to execute a program. This computer may be a physical computer, or may be a virtual machine on a cloud.

That is, the communication device 300 can be implemented by executing a program corresponding to processing performed by the communication device 300 using hardware resources such as a CPU and a memory built in a computer. The above program can be stored and distributed by being recorded in a computer-readable recording medium (portable memory or the like). The above program can also be provided through a network such as the Internet or an electronic mail.

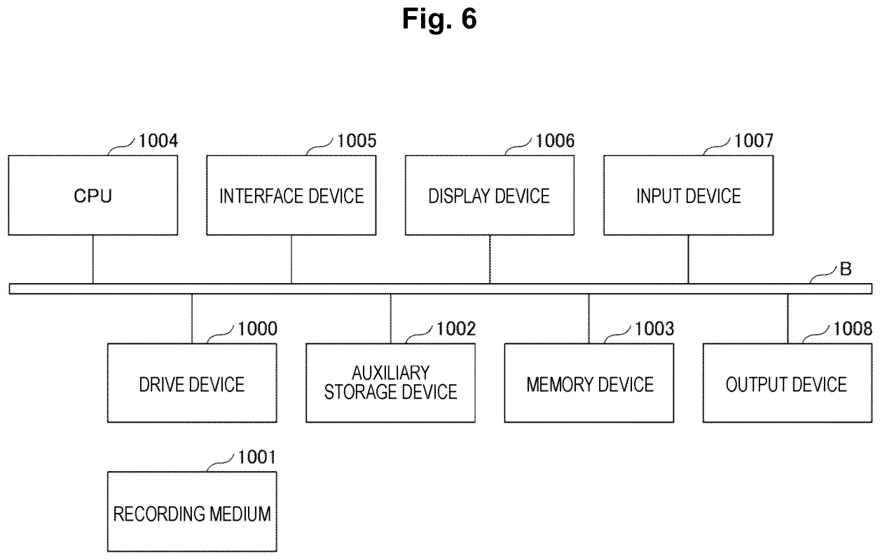

FIG. 6 is a diagram illustrating an example hardware configuration of the computer. The computer in FIG. 6 includes a drive device 1000, an auxiliary storage device 1002, a memory device 1003, a CPU 1004, an interface device 1005, a display device 1006, an input device 1007, and an output device 1008, which are connected to one another by a bus BS.

The program for implementing the processing in the computer is provided by a recording medium 1001 such as a CD-ROM or a memory card. When the recording medium 1001 storing the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program, and also stores necessary files, data, and the like.

When an instruction to start the program is made, the memory device 1003 reads the program from the auxiliary storage device 1002 and stores the program. The CPU 1004 implements a function related to the communication device 300 in accordance with the program stored in the memory device 1003. The interface device 1005 is used as an interface for connection to a network. The display device 1006 displays a graphical user interface (GUI) or the like according to the program. The input device 1007 includes a keyboard and a mouse, buttons, a touch panel, or the like, and is used to input various operation instructions. The output device 1008 outputs a calculation result.

### Effects of Embodiments

With the technology according to the present embodiment, the VAS-GW 200 can be brought into a state of holding only necessary rules on the basis of the communication start information. That is, it is possible to exclude a rule related to a terminal that is not communicating, and to apply the rule at a higher speed. As a result, high-speed transfer of user communication becomes possible.

### (Supplement)

Regarding the above embodiments, the following supplementary notes are further disclosed.

### (Supplement 1)

A communication device including:
a memory that holds a rule of a value added service policy; and
at least one processor connected to the memory,
in which the processor
adds a rule for a certain terminal to the data storage unit using a start of communication of the certain terminal as a trigger,
receives a packet related to communication of the terminal, and
executes processing related to a value added service for the packet on the basis of the added rule.

### (Supplement 2)

A communication device including:
a memory; and
at least one processor connected to the memory,
in which the processor
detects a communication start of a certain terminal, and
transmits communication start information indicating that the terminal has started communication, and transmits a packet related to communication of the terminal to a value added service providing device having a rule of a value added service policy generated on the basis of the communication start information after the transmission of the communication start information.

### (Supplement 3)

A communication system comprising a communication device, a value added service providing device, and a policy management device, in which
when the communication device detects the start of communication of a certain terminal, the communication device transmits communication start information indicating that the terminal has started communication to the policy management device,
the policy management device generates a rule of a value added service policy on the basis of the communication start information and transmits the rule to the value added service providing device, and
the value added service providing device receives a packet related to communication of the terminal and executes a process related to a value added service for the packet on the basis of the rule.

### (Supplement 4)

A communication method executed by a computer that includes a memory holding a rule of a value added service policy and functions as a communication device that performs packet communication, the communication method including:
a step of adding a rule for a certain terminal to the data storage unit with a start of communication of the certain terminal as a trigger;
a step of receiving a packet related to communication of the terminal; and
a step of executing a process related to a value added service for the packet on the basis of the added rule.

### (Supplement 5)

A communication method executed by a computer that functions as a communication device that performs packet communication, the communication method including:
a step of detecting a communication start of a certain terminal; and
a step of transmitting communication start information indicating that the terminal has started communication, and after the transmission of the communication start information, transmitting a packet related to communication of the terminal to a value added service providing device having a rule of a value added service policy generated on the basis of the communication start information.

### (Supplement 6)

A communication method in a communication system including a communication device, a value added service providing device, and a policy management device, the communication method including:
a step of transmitting, by the communication device, communication start information indicating that a certain terminal has started communication to the policy management device when the communication device detects the start of communication of the certain terminal, and
a step of generating, by the policy management device, a rule of a value added service policy on the basis of the communication start information and transmitting the rule to the value added service providing device, and
a step of receiving, by the value added service providing device, a packet related to communication of the terminal and executing a process related to a value added service for the packet on the basis of the rule.

### (Supplement 7)

A non-transitory storage medium storing a program for causing a computer to execute each process in the communication device according to supplement 1 or 2.

While the present embodiment has been described above, the present invention is not limited to such a specific embodiment, and various modifications and changes can be made within the scope of the spirit of the present invention described in the claims.

### REFERENCE SIGNS LIST

1 to 3 UE
10 GW
100 NAT-GW
20, 200 VAS-GW
250 Policy management device
260 Policy DB
30 Server
300 Communication device
310 Transmission unit
320 Reception unit
330 Control unit
340 Data storage unit
1000 Drive device
1001 Recording medium
1002 Auxiliary storage device
1003 Memory device
1004 CPU
1005 Interface device
1006 Display device
1007 Input device
1008 Output device

1. A communication device that performs packet communication, the communication device comprising:
a memory that holds a rule of a value added service policy; and
a processor coupled to the memory and configured to:
add a rule for a certain terminal to the memory using a start of communication of the certain terminal as a trigger; and
receive a packet related to communication of the terminal,
wherein processor is configured to execute processing related to a value added service for the packet on the basis of the added rule.

2. A communication device that performs packet communication, the communication device comprising:
a memory; and
a processor coupled to the memory and configured to:
detect a communication start of a certain terminal; and
transmit communication start information indicating that the terminal has started communication, and transmit a packet related to communication of the terminal to a value added service providing device having a rule of a value added service policy generated on the basis of the communication start information after the transmission of the communication start information.

3. A communication system comprising a communication device including a processor, a value added service providing device including a processor, and a policy management device including a processor, wherein,
when the processor of the communication device detects the start of communication of a certain terminal, the processor of the communication device transmits communication start information indicating that the terminal has started communication to the policy management device,
the processor of the policy management device generates a rule of a value added service policy on the basis of the communication start information and transmits the rule to the value added service providing device, and
the processor of the value added service providing device receives a packet related to communication of the terminal and executes a process related to a value added service for the packet on the basis of the rule.

4. A communication method executed by the communication device of claim 1, the communication method comprising:
adding a rule for a certain terminal to the data storage unit memory with a start of communication of the certain terminal as a trigger;
receiving a packet related to communication of the terminal; and
executing a process related to a value added service for the packet on the basis of the added rule.

5. A communication method executed by the communication device of claim 2, the communication method comprising:
detecting a communication start of a certain terminal; and
transmitting communication start information indicating that the terminal has started communication, and after the transmission of the communication start information, transmitting a packet related to communication of the terminal to a value added service providing device having a rule of a value added service policy generated on the basis of the communication start information.

6. A communication method in the communication system of claim 3, the communication method comprising:
transmitting, by the communication device, communication start information indicating that a certain terminal has started communication to the policy management device when the communication device detects the start of communication of the certain terminal, and
generating, by the policy management device, a rule of a value added service policy on the basis of the communication start information and transmitting the rule to the value added service providing device, and
receiving, by the value added service providing device, a packet related to communication of the terminal and executing a process related to a value added service for the packet on the basis of the rule.

7. A non-transitory computer-readable recording medium storing a program for causing a computer to perform the method of claim 4.

8. A non-transitory computer-readable recording medium storing a program for causing a computer to perform the method of claim 5.
